(19) United States
(12) Patent Application Publication
(10) Pub. No.: US 2024/0181283 A1
(43) Pub. Date: Jun. 6, 2024

(54) CAR PARKING GARAGE WITH WATER MIST FIRE PROTECTION SYSTEM FOR INCREASED HEIGHTS, METHODS AND WATER MIST SPRINKLERS THEREFOR

(71) Applicant: Minimax Viking Research & Development GmbH, Bad Oldesloe (DE)

(72) Inventors: Frank RÖNNFELDT, Sühlen (DE); Stefan SCHNELL, Stockelsdorf (DE)

(21) Appl. No.: 18/389,358

(22) Filed: Nov. 14, 2023

(30) Foreign Application Priority Data
Dec. 5, 2022 (EP) 22211520

(51) Int. Cl. A62C 35/68; A62C 3/02; B05B 1/26; E04H 6/42

(52) U.S. Cl. CPC A62C 35/68; A62C 3/0292; B05B 1/265; E04H 6/42

(57) ABSTRACT

The current disclosure describes car parking garages, water mist fire protection systems for car parking garages, methods and water mist sprinklers therefor, the car parking garage system (10) comprising a floor deck (50) and a ceiling deck (51) spaced about a longitudinal axis (A) extending parallel to the ceiling deck (51), defining an effective height range (H1) between the floor deck (50) and the ceiling (51) deck in a direction perpendicular to the longitudinal axis (A); and a fire protection system including a supply pipe system (30) having a parallel portion (31) disposed parallel to the longitudinal axis (A); and at least one water mist sprinkler (100) coupled to the parallel portion (31) of the supply pipe system (30), the at least one water mist sprinkler (100) including a frame body (110) having an inlet (111) for receipt of an extinguishing fluid from the supply pipe system (30), an outlet (113) with a passageway (112) extending between the inlet (111) and the outlet (113) to define a discharge coefficient of a nominal metric K-factor of below 32, a seal assembly (114) and a heat-responsive trigger (115) to support the seal assembly (114) in the outlet (113); and a deflector (120) coupled to the frame body (110) and spaced from the outlet (113) for distribution of the extinguishing fluid; wherein the effective height range (H1) is up to 4 meters.

### PRIORITY CLAIM AND INCORPORATION BY REFERENCE

This application claims the benefit of European Application No. 22211520 filed Dec. 5, 2022, which is incorporated by reference in its entirety.

### TECHNICAL FIELD

The present invention relates generally to car parking garages, water mist fire protection systems for car parking garages, methods and water mist sprinklers therefor.

### BACKGROUND OF THE INVENTION

Fire protection systems for car parking garages are typically water extinguishing systems that employ sprinklers located about the car parking garage to suppress or extinguish a lire. Car parking garages allow parking of ground vehicles, e.g. passenger cars, trucks or motorcycles, that impose an increased fire hazard risk. These fire protection systems for car parking garages can be configured as conventional sprinkler systems or as water mist systems. Water mist systems are understood by persons skilled in the art to distribute water-based extinguishing fluid with a typical drop size lower than 1 mm. The accepted industry standard VdS 3188 (10/2019 ed.) defines water mist as drops with 90% having a diameter below 1 mm in 1 meter distance to the nozzle. For a given amount of water, this lower drop size results in higher total drop surface area for water mist system than for conventional sprinkler systems, providing for a more effective fire suppression and extinguishing. Practical advantages of water mist systems over conventional sprinkler systems include lower fluid discharge rates resulting in lower risk of damage caused by extinguishing fluid, reduced pipe sizing and smaller pump and fluid tank requirements.

Known water mist sprinklers comprise a frame body that have an inlet for receipt of an extinguishing fluid, an outlet with a passageway extending between the inlet and the outlet to define a discharge coefficient of a nominal K-factor, wherein the passageway and outlet of such a sprinkler defines a nominal metric K-factor of below 32 bar. These known water mist sprinklers further include a deflector coupled to the frame body for distribution of the extinguishing fluid within the car parking garage. Discharge of extinguishing fluid from the outlet against the deflector creates a certain water mist distribution pattern within the space surrounding the water mist sprinkler.

The known water mist sprinklers further include a seal assembly and a heat-responsive trigger to support the seal assembly in the outlet. The seal assembly seals the outlet and thus prevents fluid discharge of extinguishing fluid through the outlet. Exposing the heat-responsive trigger to higher temperatures for a time activates the trigger, and activation of the heat-responsive trigger leads to the seal assembly giving way and enabling fluid connection between the inlet and the outlet. The known triggers typically comprise a heat-responsive glass bulb or a fusible link.

The known water mist sprinklers are typically attached to segments of a supply pipe system mounted to the ceiling of a car parking garage, and provide fire protection primarily to the space beneath them. For car parking garages with multiple stories, known water mist systems typically extend to the multiple stories that are designed to accommodate cars, each with segments of the supply pipe system mounted to the respective ceiling, and known water mist sprinklers attached to these segments.

The known water mist sprinklers can be installed as pendant sprinklers with the outlet directed towards the ground, or as upright sprinklers with the outlet directed away from the ground.

The supply pipe system of known water mist fire protection systems is connected to an extinguishing fluid supply, typically via a system valve, and designed to provide extinguishing fluid to the inlet of water mist sprinklers. Typically, the extinguishing fluid supply is a fluid pump. The extinguishing fluid is provided by the extinguishing fluid supply with a system fluid pressure that is higher than, or at the higher end of, the nominal fluid pressure of the individual water mist sprinklers.

Water mist sprinklers are configured to discharge water-based extinguishing fluid which may include additional agents to enhance performance, e.g. loam concentrates to provide a fire extinguishing foam, or inert gases.

Water mist fire protection systems for car parking garages can be designed as dry systems or wet systems. In dry systems, the majority of the supply pipe system up to the water mist sprinklers is filled with gas, typically pressurized air or inert gas, that is released from the supply pipe system when a water mist sprinkler opens. The supply pipe system up to the water mist sprinkler is consequently filled with extinguishing fluid, which is then discharged from the water mist sprinkler to the surrounding space.

In wet systems, the supply pipe system is already filled with extinguishing fluid up to the water mist sprinklers. Wet systems therefore allow for an immediate discharge of extinguishing fluid to the surrounding space, increasing the response time of the fire protection system. Exposing the supply pipe system to temperatures below freezing point can lead to critical damage due to the extinguishing fluid freezing and expanding in confined spaces of the pipes and sprinklers. Dry systems avoid that risk and are typically preferred unless the car parking garage is heated sufficiently.

An example of a known water mist sprinkler used for protection of car parking garages is the Minimax EconAqua MX3-U sprinkler. This known water mist sprinkler is an upright sprinkler with a nominal metric K-factor of 13.5 L/(min*bar^{1/2}), the nominal K-factor defining discharge flow Q at a given pressure P, with Q=K*√P. It includes a heat-responsive trigger with a temperature rating of 68° C. and a metric response time index (RTI) of below 50 (m*s)^{1/2}, the temperature rating being a parameter of the temperature required to activate the trigger, and the response time index being a parameter of how fast a trigger activates with lower numbers stating faster activation. This known water mist sprinkler is stated to be operated with a nominal fluid pressure of 5 bar.

This known water mist sprinkler comprises a frame body with an inlet for receipt of an extinguishing fluid, an outlet with a passageway extending between the inlet and the outlet to define a discharge coefficient of the respective nominal metric K-factor, a seal assembly and a heat-responsive trigger to support the seal assembly in the outlet; and a deflector coupled to the frame body and spaced from the outlet for distribution of the extinguishing fluid. The deflector of this known water mist sprinkler is a generally planar member with a planar central portion axially aligned with the passageway, an outer perimeter having a constant diameter and a peripheral portion located between the outer perimeter and the central portion, with the peripheral portion consisting of two segments with different geometry: a first segment approximating a frustum with a planar, angled profile, and a second curved segment, the first and second segment extending in sequence radially outwards from the central portion to the outer perimeter. The deflector of this known water mist sprinkler has multiple internal tines angled towards the outlet of the water mist sprinkler, and a maximum distance, in direction perpendicular to the plane of the planar central portion, between oppositely facing surfaces of the peripheral portion excluding tines of 2.0 mm.

Another example of a known water mist sprinkler used for protection of car parking garages is the Fire Kill OH-UPR sprinkler, an upright sprinkler with a nominal metric K-factor of 19.4 L/(min*bar^{1/2}), a typical temperature rating of 68° C. and a metric response time index below 50 (m*s)^{1/2}, and to be operated with a typical nominal fluid pressure of 6 bar.

Performance and design of known water mist fire protection systems for car parking garages are limited by the “effective height” over which the fire protection system can suppress or extinguish a fire. The effective height is defined as the vertical space or distance over which the water mist sprinkler can provide the fire protection. The effective height of the sprinkler and its installed position defines an effective height range, which is the actual distance over which fire protection can be provided within a car parking garage, and is measured as the distance between the floor deck and the ceiling deck of a car parking garage. A ceiling of a car parking garage may comprise joists which lead to locally reduced height, such locally reduced height is not considered in the art for the determination of the height of a ceiling deck, and thus is not considered for determination of the effective height range as defined herein. Car parking garages with multiple stories typically have a floor deck and a ceiling deck for each story, whereas for the purpose of this invention, floor deck and ceiling deck of one story are related, and fire protection is provided by water mist sprinklers to the space between related floor decks and ceiling decks.

Car parking garages have a minimum ceiling height for areas that allow passage of cars, which is defined by relevant construction and/or fire protection industry standards as 2 meters, for example by VdS 3883-4 (06/2020 edition). The minimum ceiling height and the effective height range define an effective height range differential, which is the difference between the minimum ceiling height of 2 meters and the effective height range.

Known water mist fire protection systems for car parking garages, such as those employing the Fire Kill OH-UPR or the Minimax EconAqua MX3-U, are limited to an effective height range of up to 3 meters. The known water mist fire protection systems fail to provide for effective fire protection over an effective height range greater than 3 meters. Due to the respective effective height range, the known water mist fire protection systems for car parking garages fail to provide for effective fire protection with an effective height range differential of more than 1 meter.

It is believed that there is a desire to provide water mist fire protection for car parking garages with greater effective heights. By increasing the effective height range of the water mist fire protection systems, car parking garages of sizes greater than currently known can be realized.

### Disclosure of the Invention

Preferred embodiments of a car parking garage, its water mist fire protection system and methods for car parking garage water mist fire protection provide for effective fire protection over a preferred effective height range of up to 4 meters.

A preferred embodiment provides a car parking garage that includes a floor deck and a ceiling deck spaced about a longitudinal axis extending parallel to the ceiling deck with a fire protection system having a supply pipe system with a parallel portion disposed parallel to the longitudinal axis, and at least one water mist sprinkler coupled to the parallel portion of the supply pipe system, the water mist sprinkler having a frame body with an inlet for receipt of an extinguishing fluid from the supply pipe system, an outlet with a passageway extending between the inlet and the outlet to define a discharge coefficient of a nominal metric K-factor of below 32; a seal assembly and a heat-responsive trigger to support the seal assembly in the outlet; and a deflector coupled to the frame body and spaced from the outlet for distribution of the extinguishing fluid, and positioned to define an effective height range of up to 4 meters, resulting in an effective height range differential of up to 2 meters. In other preferred embodiments, a method of car parking garage fire protection includes obtaining, providing and/or installing a water mist sprinkler for coupling to a parallel portion of the supply pipe system disposed parallel to the longitudinal axis in a car parking garage between a ceiling deck and a floor deck to provide an effective heights range of up to 4 meters.

The preferred car parking garages, car parking garage water mist fire protection systems, methods and water mist sprinklers therefor provide for fire protection of car parking garages at effective heights and with effective height range differentials greater than previously known.

Preferably, the supply pipe system is connected to an extinguishing fluid supply via a system valve that controls fluid flow from the extinguishing fluid supply to the supply pipe system.

In preferred configurations for car parking garages, fire protection systems for car parking garages or methods thereof, novel water mist sprinkler design provide for the car parking garage heights that are greater than previously known. A preferred water mist sprinkler design includes the water mist sprinkler having a frame body with an inlet for receipt of an extinguishing fluid from the supply pipe system, an outlet with a passageway extending between the inlet and the outlet to define a discharge coefficient of a nominal metric K-factor of below 32; a seal assembly and a heat-responsive trigger to support the seal assembly in the outlet; and a deflector coupled to the frame body and spaced from the outlet for distribution of the extinguishing fluid, wherein the deflector comprises a central portion, preferably axially aligned with the passageway, an outer perimeter, preferably having a constant diameter, and a peripheral portion located between the outer perimeter and the central portion, wherein the peripheral portion comprises three segments of different geometry. The central portion preferably comprises an aperture, even more preferably a central aperture.

In a preferred embodiment, the outer perimeter is continuous. Alternatively, the outer perimeter can also be configured as being discontinuous and having tines.

In a preferred embodiment, the water mist sprinkler is an upright sprinkler. Alternatively, the sprinkler can be designed as a pendent sprinkler.

A preferred frame body comprises a pair of frame arms, preferably opposed diametrically, about the outlet to support the deflector. The deflector preferably comprises an aperture for uptake of a locking member to maintain position of the heat-responsive trigger.

The outer perimeter is preferably centered about the central portion to define a substantially circular periphery with a constant diameter D of 30 to 50 mm, preferably of about 38 to 42 mm.

In a preferred first aspect of the deflector of the preferred design, the central portion is planar, defining a first plane preferably perpendicular to the central axis of the passageway, and the peripheral portion is non-planar. More preferably, the three segments of the peripheral portion extend in sequence radially outwards and are adjacent to one another. The first segment of the peripheral portion is a frustoconical member, approximating a frustum, with a planar profile, defining a second plane, at a first angle relative to the first plane, and extends from a boundary with the central portion, with the first angle preferably being such that the first segment is partially further away from the outlet than the central portion. The second segment is curvilinear and extends from a boundary with the first segment, the second segment being preferably curved towards the outlet. The third segment is a frustoconical member, approximating a frustum, with a planar profile, defining a third plane, at a second angle relative to the first plane, and extends from a boundary with the second segment, with the second angle preferably being such that the third segment is partially closer to the outlet than the central portion.

In a preferred second aspect of the deflector of the preferred design, the peripheral portion comprises multiple openings with internal tines. More preferably, each of the multiple openings comprise four edges, with one outer and two lateral edges defining boundaries of the opening, and one inner edge connecting to an internal tine. The internal tines are angled towards the outlet of the frame body, each internal tine defining a tine plane, the tine plane being angled to a plane of general plane of the deflector, preferably to a first plane as defined by a planar central portion, defining a tine angle. Preferably, the tine angle is between 30° and 100°.

The tine angle can vary, with every tine with the same tine angle defining one group of tines. Preferably, every internal tine of one group of tines comprises a terminal tine edge that is positioned on the same circle. Preferably, the tine angles comprise three different angles, preferably 30-50°, 45-65° and 80-100°, more preferably 35-45°, 50-60° and 85-95°, defining a first group of tines with the largest angle, a second group of tines with an intermediate angle and a third group of tines with the smallest angle. The different groups of tines deflect discharged extinguishing fluid differently to the space surrounding the water mist sprinkler, enabling elaborate manipulation of the water mist distribution pattern. More preferably, the tines are configured in a point-symmetric manner with every two tines located oppositely about the central portion being from the same group of tines.

Even more preferably, two sets of at least three, preferably five, adjacent tines are from the same, preferably the first, group of tines, and four sets of at least two adjacent tines are from another same, preferably the third, group of tines. Even more preferably, every tine located above a frame arm is from the first group of tines.

In an even more preferred second aspect, the openings have identical size and identical distance from the center, being distributed evenly about the peripheral portion with the closest lateral edges of two adjacent tines being regularly angularly spaced, and inner edge and outer edge of an opening being parallel. Preferably, the width between the lateral edges of an opening is constant. Alternatively, the width between the lateral edges of an opening is non-constant, with the width at the inner edge being larger, or smaller, than the width at the outer edge; with the lateral edges being linear or curved. Alternatively, the openings have varying sizes. Alternatively, the openings have varying distances from the center or are distributed unevenly about the peripheral portion.

In a more preferred embodiment of the deflector with the preferred first aspect and preferred second aspect of the deflector, the deflector has a peripheral portion height being defined as the maximum distance in direction perpendicular to the first plane between oppositely facing surfaces of the peripheral portion excluding tines, wherein the peripheral portion height is at least than 2.1 mm, preferably at least 2.15 mm, more preferably between 2.18 and 2.22 mm.

Applicants have discovered that using water mist sprinklers with a desired distribution pattern can provide for the preferred car parking garages, systems and methods with increased effective height ranges of up to 4 meters, preferably between greater than 3 and up to 4 meters, more preferably between 3.3 and 4 meters, even more preferably between 3.5 and 4 meters, most preferably between 3.5 and 3.7 meters. Applicants have discovered that using water mist sprinklers with a preferred nominal metric K-factor below 32, more preferred between 14 and 18, can provide for the preferred distribution pattern.

Applicants' discoveries have been verified with appropriate fire and activation testing in accordance to the testing and approval standard VdS 3883-4 (06/2020 edition) “Fire Test Protocol for Water Mist Systems, Part 4: Protection of car garages”.

Alternatively or additionally, applicants have discovered that the desired distribution pattern can be realized by combinations of preferred nominal metric K-factor and preferred water mist sprinklers with preferred frame body and preferred deflector to provide for the desired distribution pattern. The preferred car parking garages, systems and methods with the desired distribution pattern provide for an increase in car parking garages effective height range differential by as much as 100% over known car parking garages with known water mist fire protection systems.

Applicants have also discovered that using water mist sprinklers with a heat-responsive trigger with a response time index (RTI) of 50 to 80 (m*s)^{1/2} provide for a preferred activation time for the preferred car parking garages, systems and methods with increased effective height ranges. In one preferred embodiment, the trigger is a heat-responsive glass bulb with an RTI of 68 (m*s)^{1/2} Heat-responsive triggers can be alternatively embodied as soldered links or strut and lever assemblies as known in the art.

A preferred method of car parking garage fire protection includes installing a supply pipe system between a ceiling deck and a floor deck of a car parking garage to provide for an effective height range of up to 4 meters; and coupling at least one water mist sprinkler to a portion of the supply pipe system parallel to the ceiling deck; and a ceiling deck for protection over the effective height range.

Another preferred method of car parking garage fire protection includes obtaining a water mist sprinkler coupled to a supply pipe system, including a frame body having an inlet for receipt of an extinguishing fluid, an outlet with a passageway extending between the inlet and the outlet to define a discharge coefficient of a nominal K-factor, a seal assembly, a heat-responsive trigger to support the seal assembly in the outlet, and a deflector coupled to the frame body and spaced from the outlet for distribution of the extinguishing fluid; and providing the water mist sprinkler for installation in a car parking garage to provide for an effective height range of up to 4 meters.

### DESCRIPTION OF THE DRAWINGS

The accompanying drawings, which are incorporated herein and constitute part of this specification, illustrate exemplary embodiments of the invention, and together, with the general description given above and the detailed description given below, serve to explain the features of the invention. It should be understood that the preferred embodiments are some examples as provided by the appended claims.

FIG. 1 is a plan view of a preferred car parking garage and fire protection system.

FIG. 2 is an elevation view of a preferred car parking garage and fire protection system.

FIG. 3 is an elevation view, with a partial cross-sectional view along axis B on the right-hand side, of a preferred water mist sprinkler for use in the systems of FIGS. 1 and 2.

FIG. 4 is an elevation view, with a partial cross-sectional view along axis B on the right-hand side, of a preferred deflector for use in a preferred water mist sprinkler.

FIG. 5 is a plan view of the preferred deflector of FIG. 4.

FIG. 6 is a schematic cross-sectional drawing along axis C of a first aspect of the preferred deflector of FIGS. 4 and 5.

FIG. 7 is a schematic cross-sectional drawing along axis B of a second aspect of the preferred deflector of FIGS. 4 and 5.

FIG. 8 is a schematic drawing of a preferred embodiment of the second aspect as shown in FIG. 7.

### DETAILED DESCRIPTION

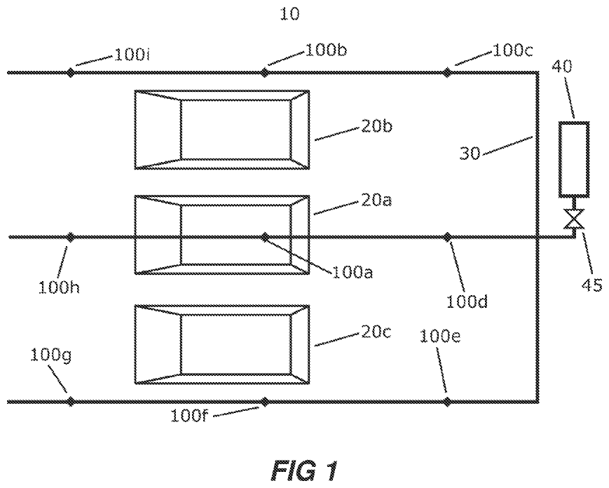

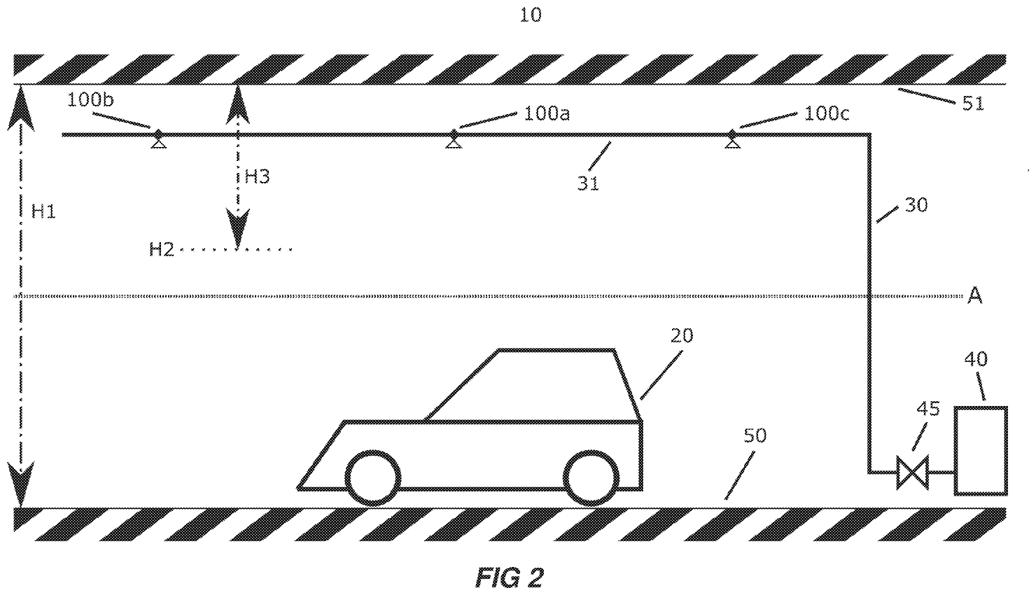

FIGS. 1 and 2 show a car parking garage 10 according to a preferred embodiment of the invention. The car parking garage 10 has a water mist fire protection system to provide lire protection an area of the car parking garage 10 that is designed to accommodate cars 20,20a-c. The car parking garage 10 has a floor deck 50 and a ceiling 51 that are spaced about a longitudinal axis A extending parallel to the ceiling deck 51. The floor deck 50 and the ceiling deck 51 define an effective height range H1 as the distance between the floor deck 50 and the ceiling deck 51 in a direction perpendicular to the longitudinal axis A. The car parking garage 10 further has a minimum ceiling height H2 in the direction perpendicular to the longitudinal axis A which together with the effective height range H1 defines an effective height range differential H3 as the difference between H1 and H2.

The water mist fire protection system includes an extinguishing fluid supply 40 connected to a supply pipe system 30 via a system valve 45. The supply pipe system 30 has a parallel portion 31 parallel to the ceiling deck 51, the parallel portion 31 of the supply pipe system having water mist sprinklers 100a-i coupled to it, to provide for fire protection over the effective height range H1, with the effective height range differential H3 over the minimum ceiling height H2.

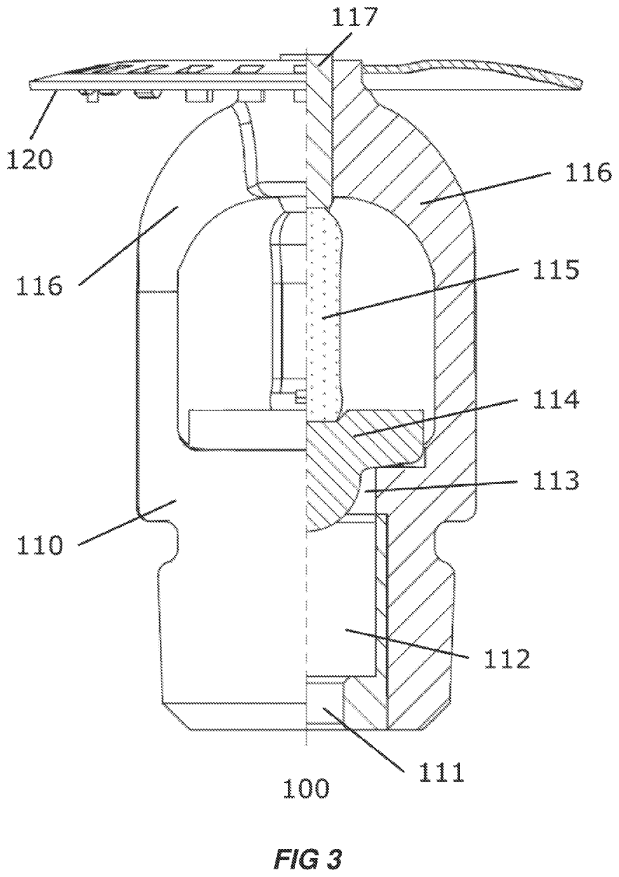

FIG. 3 shows a water mist sprinkler 10 according to a preferred embodiment of the invention for use in fire protection system of a car parking garage 10. The water mist sprinkler 10 has a frame body 110 which has an inlet 111 for receipt of an extinguishing fluid from a fluid supply pipe system, an outlet 113, a passageway 112 extending between the inlet 111 and the outlet 113 wherein the outlet 113 and the passageway 112 define a discharge coefficient of a nominal K-factor, and a pair of frame arms 116. The water mist sprinkler 10 further has a seal assembly 114 and a heat-responsive trigger 115, here shown as a fluid-containing glass bulb, to support the seal assembly 114 in the outlet 113, the heat-responsive trigger 115 being held in position by a locking member 117. The water mist sprinkler 10 has a deflector 120 to distribute discharged extinguishing fluid to a surrounding space to provide for a water mist distribution pattern, the deflector 120 being supported by the frame arms.

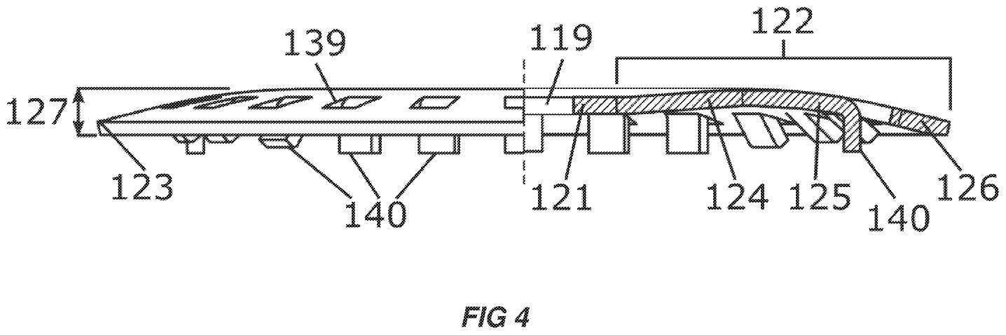

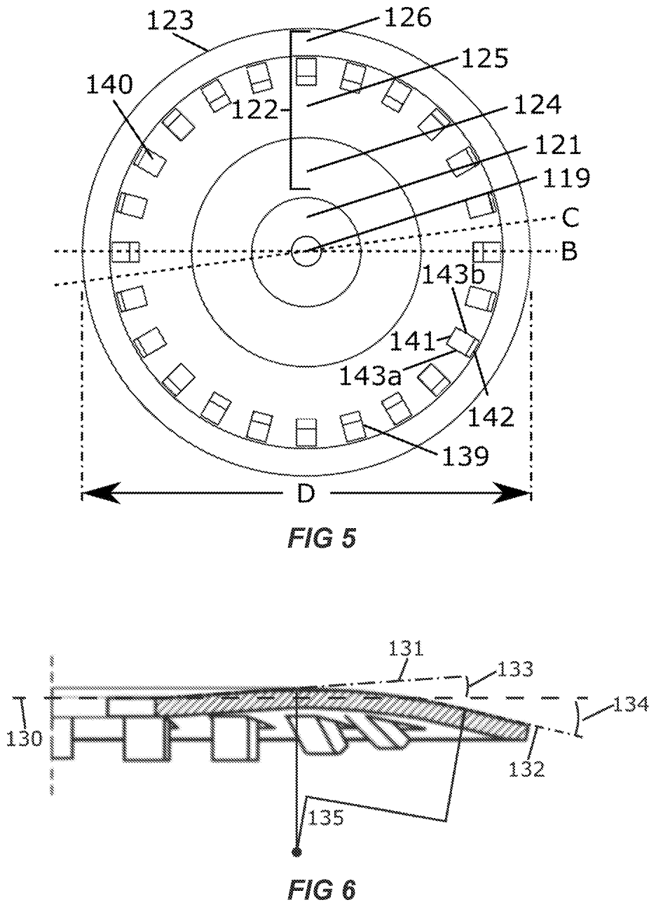

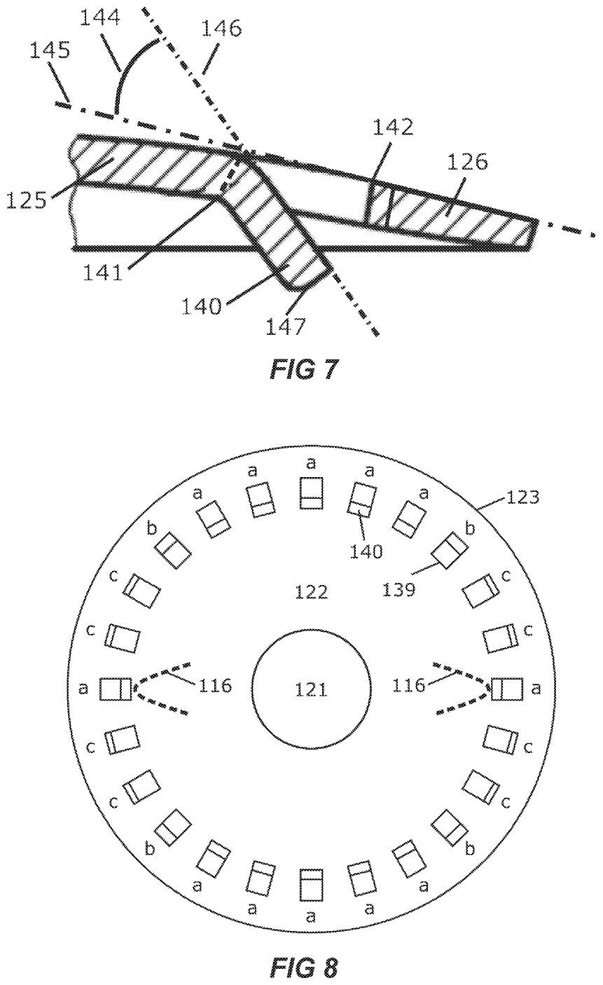

FIGS. 4 and 5 show a preferred deflector 120 for use in a water mist sprinkler 10, and FIGS. 6 and 7 show a first and a second aspect of that preferred deflector 120. The deflector 120 has a planar central portion 121 defining a first plane 130, an outer perimeter 123 with a constant diameter D defining a circular periphery, and a peripheral portion 122 located between the central portion 121 and the outer perimeter 123. The central portion 121 surrounds an aperture 119 for uptake of a locking member 117. The deflector 120 is to be coupled to frame arms 116 of a frame body 110 such that the frame body 110, more specifically an outlet 113 of the frame body 110, is below the deflector 120 oriented as shown in FIG. 4.

The peripheral portion 122 as shown in FIGS. 4 and 6 has a first segment 124, a second segment 125 and third segment 126, the three segments 124,125,126 extending in sequence radially outwards towards the outer perimeter 123 and being adjacent to one another. The first segment 124 is a frustoconical member, approximating a frustum, with a planar profile, defining a second plane 131, at a first angle 133 relative to the first plane 130, and extends from a boundary with the central portion 121, the first segment 124 being partially further away from an outlet 113 than the central portion 121. The second segment 125 is curvilinear with a curvature 135 and extends from a boundary with the first segment 124, the second segment 125 being curved towards an outlet 113 as it extends radially outwards. The third segment 126 is a frustoconical member, approximating a frustum, with a planar profile, defining a third plane 132, at a second angle 134 relative to the first plane 130, and extends from a boundary with the second segment 125, the third segment 126 being partially closer to an outlet 113 than the central portion 121.

The peripheral portion 122 as shown in FIGS. 4, 5 and 7 has multiple openings 139 with internal tines 140. Each of the multiple openings 139 have four edges 141-143, with one outer edge 142 and two lateral edges 143a,b defining boundaries of the opening 139, and one inner edge 141 connecting to an internal tine 140. The internal tines 140 are angled towards an outlet 113 of a frame body 110, each internal tine 140 defining a tine plane 146, the tine plane 146 being angled to the first plane 130 with the tine angle 144. The internal tines 140 each have an terminal tine edge 147, located at the distal end of the tine 140 and facing towards the outlet 113.

The openings 139 are of identical size and have an identical distance from the center. They are distributed evenly about the peripheral portion 122 with the closest lateral edges 143a,b of two adjacent tines being regularly angularly spaced. The inner edge 141 and the outer edge 142 are parallel and the width between the lateral edges 143a,b of an opening 139 is constant, defining a rectangular shape of each opening 139. The peripheral portion 122 has a height 127 as the maximum distance between its oppositely facing surfaces excluding tines 140, in a direction perpendicular to the first plane.

FIG. 8 shows a preferred embodiment of the second aspect of the preferred deflector as shown in FIG. 7. In this preferred embodiment, each internal tine 140 belongs to either a first group of tines a, a second group of tines b or a third group of tines c, with each tine 140 of the same group a, b or c having the same tine angle 144, with the first group of tines a having the largest tine angle 144, the second group b having an intermediate tine angle 144 and the third group c having the smallest tine angle 144. The members 140 of each group of tines a,b,c are arranged in a point-symmetric manner, with every two tines 140 located oppositely about the central portion 121 being from the same group of tines a,b,c. Two oppositely located sets of five adjacent internal tines 140 are from the first group of tines a, and four sets of two adjacent internal tines 140 are from the third group of tines c, with two pairs of two sets of tines 140 of group c being located oppositely about the central portion 121. Two individual tines 140 located each above the opposing frame arms 116, or on an axis defined by the frame arms 116, are from the first group of tines a.

The circular arrangement sequence of tines 140 of this embodiment is: a-2×c-b-5×a-b-2×c-a-2×c-b-5×a-b-2×c, with the sequence starting on one of the two individual tines 140 located above the opposing frame arms 116.

### LIST OF REFERENCES

10 car parking garage
20, 20a-c car
30 supply pipe system
31 parallel portion of supply pipe system
40 extinguishing fluid supply
45 system valve
50 floor deck
51 ceiling deck
100, 100a-l water mist sprinkler
110 frame body
111 inlet
112 passageway
113 outlet
114 seal assembly
115 heat-responsive trigger
116 frame arms
117 locking member
119 locking aperture
120 deflector
121 central portion
122 peripheral portion
123 outer perimeter
124 first segment
125 second segment
126 third segment
127 peripheral portion height
130 first plane
131 second plane
132 third plane
133 first angle
134 second angle
135 curvature
139 internal opening
140, 140a-e internal tine
141 inner edge
142 outer edge
143, 143a,b lateral edges
144 tine angle
146 tine plane
147 tine terminal edge
A longitudinal axis
H1 effective height range
H2 minimum ceiling height
H3 effective height range differential
D deflector diameter
a, b, c first, second, third group of tines
B, C cross-section axes

1. A car parking garage system comprising:
a floor deck and a ceiling deck spaced about a longitudinal axis extending parallel to the ceiling deck, defining an effective height range between the floor deck and the ceiling deck in a direction perpendicular to the longitudinal axis; and
a fire protection system including:
a supply pipe system having a parallel portion disposed parallel to the longitudinal axis; and
at least one water mist sprinkler coupled to the parallel portion of the supply pipe system, the at least one water mist sprinkler including
a frame body having an inlet for receipt of an extinguishing fluid from the supply pipe system, an outlet with a passageway extending between the inlet and the outlet to define a discharge coefficient of a nominal metric K-factor of below 32, a seal assembly and a heat-responsive trigger to support the seal assembly in the outlet; and
a deflector coupled to the frame body and spaced from the outlet for distribution of the extinguishing fluid;
wherein the effective height range is up to 4 meters.

2. The system of claim 1, wherein the fire protection system includes a plurality of water mist sprinklers coupled to the parallel portion of the supply pipe system.

3. The system of claim 1, wherein the passageway and the outlet of the at least one water mist sprinkler defines a nominal metric K-factor between 14 and 18.

4. The system of claim 1, wherein the heat-responsive trigger has a metric response time index between 50 and 80.

5. The system of claim 1, the deflector comprising a central portion, an outer perimeter and a peripheral portion located between the central portion and the outer perimeter, wherein the peripheral portion comprises three segments of different geometry.

6. The system of claim 5, wherein the outer perimeter has a constant radius.

7. The system of claim 6, wherein the outer perimeter is continuous.

8. The system of claim 7, wherein the central portion is planar and the peripheral portion is non-planar.

9. The system of claim 8, wherein the three segments of the peripheral portion extend in sequence radially outwards and are adjacent to one another.

10. The system of claim 9, wherein the third segment is a frustoconical member, approximating a frustum, with a planar profile.

11. The system of claim 10, wherein the peripheral portion comprises multiple openings with internal tines.

12. The system of claim 1, wherein the effective height range is greater than 2 and up to 4 meters.

13. The system of claim 12, wherein the effective height range is greater than 3 and up to 4 meters.

14. The system of claim 13, wherein the effective height range is between 3.3 and 4 meters.

15. The system of claim 14, wherein the effective height range is between 3.5 and 4 meters.

16. The system of claim 15, wherein the effective height range is between 3.5 and 3.7 meters.

17. The system of claim 1, wherein a effective height range differential is up to 2 meters.

18. A method of car parking garage fire protection comprising:
obtaining a fire protection system comprising
a supply pipe system having a parallel portion disposed parallel to a longitudinal axis, at least one water mist sprinkler coupled to the parallel portion of the supply pipe system, the at least one water mist sprinkler including a frame body having an inlet for receipt of an extinguishing fluid from the supply pipe system, an outlet with a passageway extending between the inlet and the outlet to define a discharge coefficient of a nominal metric K-factor of below 32;
a seal assembly and a heat-responsive trigger to support the seal assembly in the outlet; and
a deflector coupled to the frame body and spaced from the outlet for distribution of the extinguishing fluid;
providing the at least one water mist sprinkler for installation in a car parking garage between a floor deck and a ceiling deck of a car parking garage spaced about the longitudinal axis extending parallel to the ceiling deck, defining an effective height range between the floor deck and the ceiling deck in a direction perpendicular to the longitudinal axis,
wherein the effective height range is up to 4 meters.

19. A method of car parking garage fire protection comprising:
installing a supply pipe system between a ceiling deck and a floor deck of a car parking garage spaced about a longitudinal axis extending parallel to the ceiling deck, defining an effective height range between the floor deck and the ceiling deck in a direction perpendicular to the longitudinal axis; and
coupling at least one water mist sprinkler to a parallel portion of the supply pipe system disposed parallel to the floor deck,
the at least one water mist sprinkler including a frame body having an inlet for receipt of an extinguishing fluid from the supply pipe system, an outlet with a passageway extending between the inlet and the outlet to define a discharge coefficient of a nominal metric K-factor of below 32, a seal assembly and a heat-responsive trigger to support the seal assembly in the outlet, and a deflector coupled to the frame body and spaced from the outlet for distribution of the extinguishing fluid, and the ceiling deck for protection over the effective height range,
wherein the effective height range is up to 4 meters.

20. The method of claim 19, wherein the effective height range is greater than 3 and up to 4 meters.

21. A water mist nozzle for car parking garage systems of claim 1, the deflector comprising a central portion, an outer perimeter and a peripheral portion located between the central portion and the outer perimeter,
wherein the peripheral portion comprises three segments of different geometry.

22. The water mist nozzle of claim 21, wherein
the heat-responsive trigger has a metric response time index between 50 and 80,
the outer perimeter is continuous and has a constant radius,
the three segments of the peripheral portion extend in sequence radially outwards and are adjacent to one another,
the third segment is a frustoconical member, approximating a frustum, with a planar profile,
the peripheral portion comprises multiple openings with internal tines.
